(19) United States
(12) Patent Application Publication
(10) Pub. No.: US 2020/0327615 A1
(43) Pub. Date: Oct. 15, 2020

(54) PORTFOLIO RISK MEASURES AGGREGATION

(71) Applicant: SS&C Technologies, Inc., Windsor, CT (US)

(72) Inventors: Oleg Frenkel, Thornhill (CA); Leonid Isupov, Toronto (CA)

(21) Appl. No.: 16/379,965

(22) Filed: Apr. 10, 2019

(51) Int. Cl. G06Q 40/06

(52) U.S. Cl. CPC G06Q 40/06

(57) ABSTRACT

Disclosed embodiments provide a computer-implemented technique for risk measure aggregation. An instrument simulation data table is created, comprising, for each instrument, a two-dimensional array defining scenarios and timestep simulation information. Each record holds timesteps, and simulation information for a plurality of scenarios, for an instrument from the plurality of financial instruments. A reverse portfolio data table is created, comprising, for each instrument, a tuple comprising position units for a portfolio from a plurality of portfolios. Each portfolio includes one or more instruments from the plurality of financial instruments. The instrument simulation data table and the reverse portfolio data table are joined based on an instrument identifier to create an instrument information table. The instrument information table comprises one record per instrument. Each record comprises data fields of instrument, simulation values, and position units by portfolio.

### FIELD

The present invention relates generally to financial risk management, and more particularly to portfolio risk measures aggregation.

### BACKGROUND

Risk measurement is a vital part of portfolio construction and oversight. Investment policy is often based on a portfolio's risk management goals. Risk measures and other metrics are often used to estimate the expected performance of a portfolio under various conditions as part of “what-if” scenarios. Reliance on inaccurately computed risk measures can lead to suboptimal investment decisions.

### SUMMARY

In one embodiment, there is provided a computer-implemented method for risk measure calculation for a plurality of financial instruments, comprising: creating an instrument simulation data table, comprising, for each instrument, a two-dimensional array defining scenarios and timestep simulation information, wherein each record contains timesteps, and simulation information for a plurality of scenarios, for an instrument from the plurality of financial instruments; creating a reverse portfolio data table, comprising, for each instrument, a tuple comprising position units for a portfolio from a plurality of portfolios, wherein each portfolio includes one or more instruments from the plurality of financial instruments; and joining the instrument simulation data table and the reverse portfolio data table based on an instrument identifier to create an instrument information table comprising one record per instrument, wherein each record comprises data fields of instrument, simulation values, and position units by portfolio.

In another embodiment, there is provided an electronic computation device comprising: a processor; a memory coupled to the processor, the memory containing instructions, that when executed by the processor, perform the process of: creating an instrument simulation data table, comprising, for each instrument, a two-dimensional array defining scenarios and timestep simulation information, wherein each record contains timesteps, and simulation information for a plurality of scenarios, for an instrument from the plurality of financial instruments; creating a reverse portfolio data table, comprising, for each instrument, a tuple comprising position units for a portfolio from a plurality of portfolios, wherein each portfolio includes one or more instruments from the plurality of financial instruments; and joining the instrument simulation data table and the reverse portfolio data table based on an instrument identifier to create an instrument information table comprising one record per instrument, wherein each record comprises data fields of instrument, simulation values, and position units by portfolio.

In yet another embodiment, there is provided a computer program product for an electronic computation device comprising a computer readable storage medium having program instructions embodied therewith, the program instructions executable by a processor to cause the electronic computation device to perform the process of: creating an instrument simulation data table, comprising, for each instrument, a two-dimensional array defining scenarios and timestep simulation information, wherein each record contains timesteps, and simulation information for a plurality of scenarios, for an instrument from the plurality of financial instruments; creating a reverse portfolio data table, comprising, for each instrument, a tuple comprising position units for a portfolio from a plurality of portfolios, wherein each portfolio includes one or more instruments from the plurality of financial instruments; and joining the instrument simulation data table and the reverse portfolio data table based on an instrument identifier to create an instrument information table comprising one record per instrument, wherein each record comprises data fields of instrument, simulation values, and position units by portfolio.

### BRIEF DESCRIPTION OF THE DRAWINGS

Features of the disclosed embodiments will be more readily understood from the following detailed description of the various aspects of the invention taken in conjunction with the accompanying drawings.

FIG. 1 shows an environment for embodiments of the present invention.

FIG. 2 shows an instrument simulation data table in accordance with embodiments of the present invention.

FIG. 3A shows a reverse portfolio data table in accordance with embodiments of the present invention.

FIG. 3B shows an alternative embodiment for storing reverse portfolio data.

FIG. 4 shows an instrument information table in accordance with embodiments of the present invention.

FIG. 5 shows an embodiment of the present invention utilizing a distributed computing architecture.

FIG. 6 shows a block diagram of an electronic computing device in accordance with embodiments of the present invention.

FIG. 7 is a flowchart indicating process steps for embodiments of the present invention.

FIG. 8 shows an example of calculating aggregation values for a portfolio in a distributed computing architecture.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Disclosed embodiments provide a computer-implemented technique for risk measure aggregation. An instrument simulation data table is created, comprising, for each financial instrument, information defining scenarios and timestep simulation information. In embodiments, the information can be implemented as a two-dimensional array. Each record contains timesteps, and simulation information for a plurality of scenarios, for an instrument from the plurality of financial instruments. Timesteps can be periodic intervals such as days, weeks, quarters, months, years, and/or other suitable intervals. A reverse portfolio data table is created, comprising, for each instrument, a tuple comprising position units for a portfolio from a plurality of portfolios. Each portfolio includes one or more instruments from the plurality of financial instruments. The instrument simulation data table and the reverse portfolio data table are joined based on an instrument identifier to create an instrument information table. The instrument information table comprises one record per instrument. Each record comprises data fields of instrument, simulation values, and position units by portfolio.

Evaluation of financial risk typically involves simulation of financial instruments such as stocks, bonds, and funds for some future time horizon based on applicable risk factors for multiple scenarios. It is also necessary to compute risk for portfolios that contain multiple instruments. Since probability distribution is different for different instruments, portfolio risk measures are not additive. Portfolio risk measures cannot be adequately computed simply by independently calculating measures for instruments. To calculate risk measure at a portfolio level, a portfolio value is obtained over a set of scenarios based on aggregation of instrument results accounting for instrument positions in each portfolio.

Heretofore, this process has required huge data storage requirements for computational data and a long processing time. For that reason, most risk-reporting warehouses take a shortcut of pre-aggregating all frequently used simulations and use the pre-aggregated values to derive risk measures, such as Value at Risk (VaR). This approach provides a coarse estimate, as the available views are limited and fixed. Computing a risk measure for a new set of assets, requires a new aggregation job, and thus users have to wait for results (for hours or even days).

The disclosed embodiments improve the technical field of financial risk management by organization of data utilizing a reverse portfolio data table and an instrument information table. These tables enable efficient aggregation techniques based on Big Data technology (e.g., Hadoop, Spark, Hive, and/or related suites of components) which allows optimization of data volume and reduction of processing time during aggregation in a distributed computing environment.

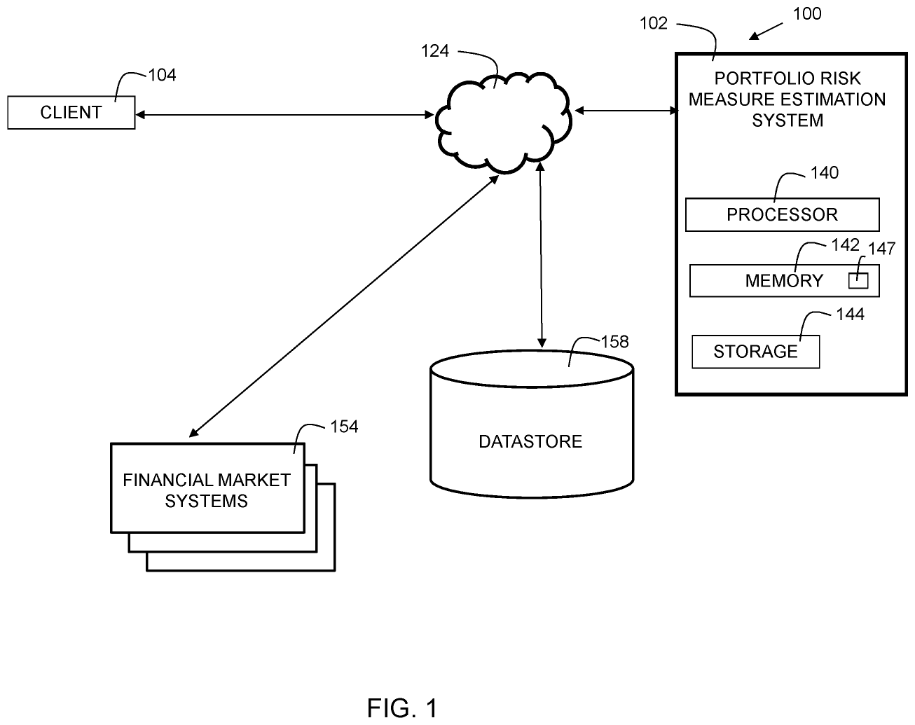

FIG. 1 shows an environment 100 for embodiments of the present invention. Portfolio risk measure estimation system 102 comprises a processor 140, a memory 142 coupled to the processor 140, and storage 144. System 102 is an electronic computation device. The memory 142, contains instructions 147, that when executed by the processor 140, perform embodiments of the present invention. Memory 142 may include dynamic random-access memory (DRAM), static random-access memory (SRAM), magnetic storage, and/or a read only memory such as flash, EEPROM, optical storage, or other suitable memory. In some embodiments, the memory 142 may not be a transitory signal per se. In some embodiments, storage 144 may include one or more magnetic storage devices such as hard disk drives (HDDs). Storage 144 may additionally include one or more solid state drives (SSDs). System 102 is connected to network 124, which is the Internet, a wide area network, a local area network, or other suitable network.

Datastore 158 comprises computer-accessible electronic records and/or databases that include financial data. The financial data can include information regarding specific financial instruments such as stocks, bonds, funds, currencies, commodities, exchanges, and/or other financial information. The financial data may include, for each instrument, additional metadata, such as industry sector, country of origin, capitalization levels, financial dependencies, and/or other suitable financial information. The financial dependency information can include an indication of how much impact the price of a given commodity affects the instrument. As an example, the price of oil has a significant impact on transportation industry stocks such as those of airlines and shipping companies. The datastore 158 may be stored in a SQL (Structured Query Language) format such as MySQL, a NoSQL format, such as MongoDB, or other suitable storage format now known or hereafter developed.

The environment 100 may include one or more financial market systems 154. The financial market systems may include one or more exchanges, including, but not limited to, the New York Stock Exchange (NYSE), NASDAQ, Tokyo Stock Exchange (TSE), London Stock Exchange (LSE), Chicago Mercantile Exchange, Foreign Exchange Market (Forex), cryptocurrency exchanges, and/or other suitable trading platforms. In embodiments, the portfolio risk measure estimation system 102 can automatically initiate purchase and/or sale of instruments on the financial market systems 154 via application programmer interface (API) calls, automated trading systems that interface with the exchanges, and/or other suitable technique, via network 124.

Client device 104 is connected to network 124. Client device 104 is a user computing device, such as a tablet computer, laptop computer, desktop computer, smartphone, PDA, or other suitable device that can communicate over a computer network.

The client device 104 may be used to provide information to the portfolio risk measure estimation system 102 via a user interface such as a HTML-based user interface. The information can include, but is not limited to, what-if scenarios, simulation scenarios, and/or requests for computation of one or more risk measures. The risk measures can include, but are not limited to, value at risk (VaR), expected shortfall (ES), alpha, beta, Sharpe ratio, R-squared, and/or other suitable risk measures. Although one client device is shown, in implementations, more client devices can be in communication with the system 102 shown via the network 124.

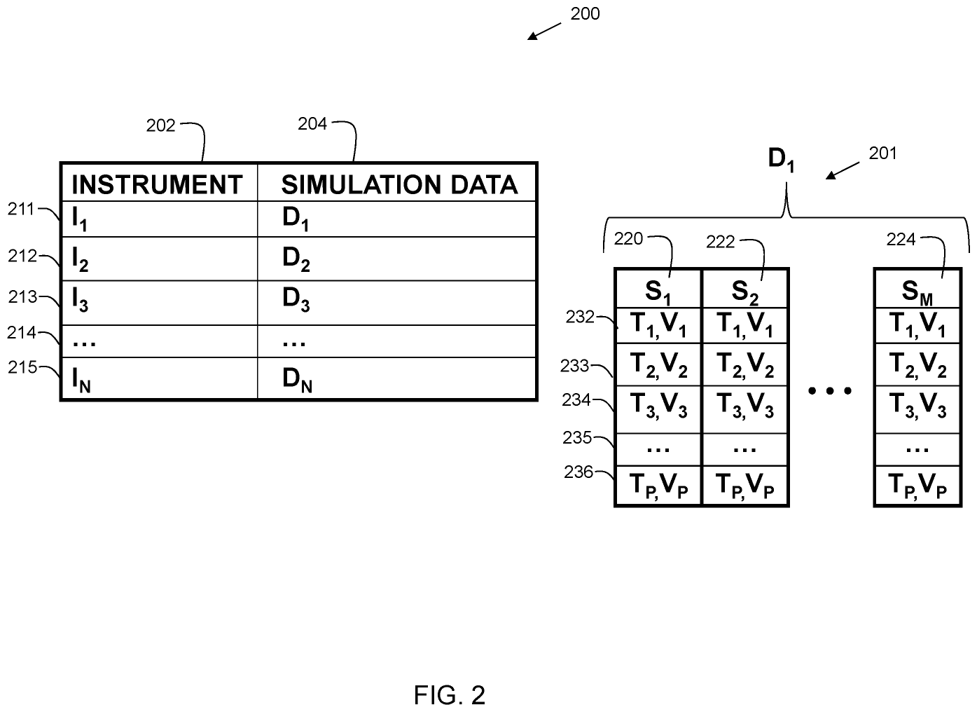

FIG. 2 shows an instrument simulation data table 200 in accordance with embodiments of the present invention. Table 200 includes column 202 for each instrument that may be included in a portfolio. Each financial instrument may be designated by an identifier (indicated as I₁, I₂, I₃, etc.). The identifier may be an alphanumeric identifier. For each instrument in column 202, a corresponding set of simulation data is stored at column 204. Throughout this disclosure, the term ‘record’ and ‘row’ may be used interchangeably. Thus, in row 211, instrument I₁ has simulation data D₁, in row 212, instrument I₂ has simulation data D₂, and so on. As shown in FIG. 2, five rows, 211, 212, 213, 214, and 215 are shown. In practice, the table 200 may have many more rows than five. Row 214, with the “ . . . ” symbol, indicates that many additional rows may be in place between row 213, and the final row 215. As shown in row 215, the instrument identifier I_{N} indicates that it is the last identifier in a table of size N. Thus, if N is 3,000, then the identifier I_{N} in row 215 is I₃₀₀₀.

The simulation data for D₁ is shown in additional detail at 201. The simulation data D₁ may include a two-dimensional array of tuples of M columns by P rows, where M represents the number of scenarios, and P represents the number of timesteps per scenario. Thus, each column represents a particular simulation scenario. Column 220 represents scenario S₁, column 222 represents scenario S2, and so on, up to column 224 which represents scenario M. In embodiments, M may range from 1 to 5,000. In some embodiments, M may exceed 5,000. For each scenario, a tuple, comprising timestep simulation information, is stored in the form T_{I}V_{I}, where T₁ is a time at some point in the future, and V_{I} is the value of the corresponding instrument at that time. The time increment used can be hours, days, weeks, months, quarters, years, or other suitable time increment. The scenario has P time increments. Thus, the last row 236 has the tuple index T_{P}V_{P} for a given simulation scenario. As an example, for a simulation scenario forecasting risk measures 12 weeks into the future with a time increment of one week, then row 232 represents the value of an instrument at one week into the future. Similarly, row 233 represents the value of the instrument at two weeks into the future, and so on with rows 234, 235 (which can represent multiple rows with the “ . . . ” symbol), up to row 236, which, in this example, represents the value of the instrument at 12 weeks into the future. Thus, in this example, P is equal to 12.

In practice, multiple scenarios are computed. As shown at 201, there are M scenarios computed. Each scenario can incorporate data for different conditions. As an example, scenario S₁ can include estimated instrument value data for a case where interest rates rise, and scenario S₂ can include estimated instrument value data for a case where interest rates fall, etc. Other scenarios can include considerations for change in commodity prices (e.g., crude oil, wheat, soy), changes in currency valuation (e.g., value of the Euro as compared with the U.S. dollar), and/or expected change in supply/demand of goods and/or services. While 201 indicates a structure for D₁, structures D₂, D₃, and other simulation data elements have a similar data structure corresponding to simulation values for their respective instrument.

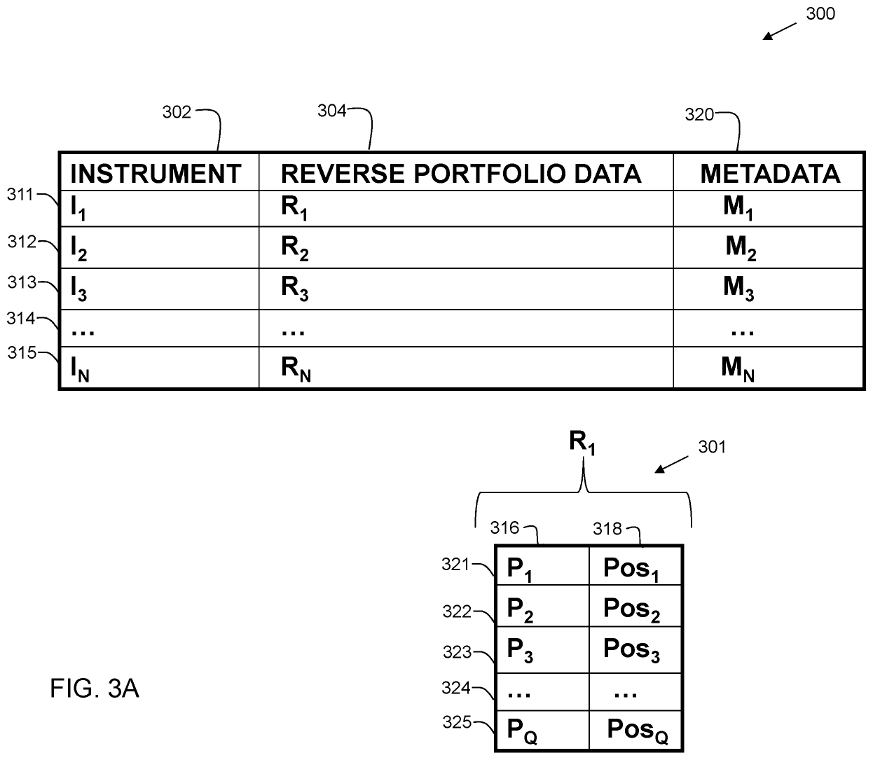

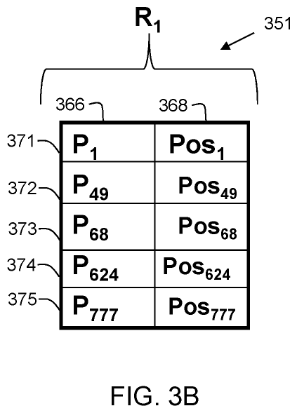

FIG. 3A shows a reverse portfolio data table 300 in accordance with embodiments of the present invention. Table 300 includes column 302 for each financial instrument that may be included in a portfolio. Each instrument may be designated by an identifier (indicated as I₁, I₂, I₃, etc.).

Investments typically include portfolios, which are collections of instruments. As an example, a stock portfolio may include various amounts of stock of multiple corporations. A bond portfolio may include various amounts of different bonds. Mixed portfolios may include a mix of bonds, stocks, mutual funds, and/or other instruments. The amount of a given instrument in a portfolio is referred to as a “position.”

For each instrument in column 302, corresponding reverse portfolio data is stored at column 304. Thus, in row 311, instrument I₁ has reverse portfolio data R₁, in row 312, instrument I₂ has reverse portfolio data R₂, and so on. As shown in FIG. 3, five rows, 311, 312, 313, 314, and 315 are shown. In practice, the table 300 may have many more rows than five. Row 314, with the “ . . . ” symbol, indicates that many additional rows may be in place between row 313, and the final row 315. As shown in row 315, the instrument identifier I_{N} indicates that it is the last identifier in a table of size N. Thus, if N is 3,000, then the identifier I_{N} in row 315 is I₃₀₀₀.

The reverse portfolio data of R₁ is shown in additional detail at 301. The reverse portfolio data of R₁ includes each portfolio included in the simulation pool. Column 316 indicates a portfolio identifier. In embodiments, the portfolio identifier may be an alphanumeric code. Column 318 indicates position units of a specific instrument in the portfolio. Thus, the representation is a “reverse portfolio data table” in that for each instrument, its position in each portfolio is represented in the reverse portfolio data. Thus, each row contains a tuple comprising a portfolio identifier and corresponding position units (e.g., shares, dollars, etc.) for that portfolio. As an example, instrument I₁ represents stock of Company A, and a first portfolio includes 100 shares of company A stock and a second portfolio includes 300 shares of company A stock. In this example, Pos₁ at row 321 column 318 has a value of 100, and Pos₂ at row 322 column 318 has a value of 300. Rows 323, 324, and 325 represent entries for additional portfolios. In general, there may be Q portfolios. For each portfolio, the position for a given instrument is denoted in the corresponding entry in column 318. In the case where a portfolio does not contain any shares/amounts of a particular instrument, the value in the corresponding entry in column 318 may be zero.

Optionally, table 300 may further include column 320 for metadata corresponding to each instrument. The metadata can include additional information such as instrument type (e.g., stock, bond, fund, etc.), instrument sector (e.g., healthcare, energy, technology, etc.), country of origin (e.g., United States, Canada, Japan, etc.), capitalization level (e.g., small, medium, large), and/or other metadata. The metadata can be used to conduct various simulations on a portfolio. For example, a VaR risk measure can be computed for a given portfolio P_{X} where X is a number ranging from 1 to Q. As an example, if it is desired to compute a VaR measure if the portfolio contains no healthcare related instruments, then a new portfolio referred to as P_{Y} can be created by copying portfolio P_{X} and then removing all instruments with a category of healthcare, by removing instruments from portfolio P_{Y} that are categorized as such in column 320.

FIG. 3B shows an alternative embodiment for storing reverse portfolio data. In some situations, an instrument may only be used in a few portfolios. In some embodiments, a sparse block data structure at 351 may be used to store portfolio data instead of 301 of FIG. 3A. With a sparse block, only portfolios that contain a non-zero amount of an instrument are included in the reverse portfolio table. In this way, if there are thousands of portfolios, and only a small number contain a non-zero amount of a given instrument, the reverse portfolio data is small. If, during the course of executing various what-if scenarios, a new portfolio is created that includes the instrument, the new portfolio is added to the sparse block data structure 351. Furthermore, if an instrument is added to, or removed from, an existing portfolio, the sparse block is updated accordingly by adding or removing a portfolio entry. In this way, additional memory resources are conserved. Thus, embodiments can include representing reverse portfolio data in a sparse block.

As shown in FIG. 3B, column 366 indicates a portfolio identifier. In embodiments, the portfolio identifier may be an alphanumeric code or another suitable identifier. Column 368 indicates position units of a specific instrument in the portfolio. Thus, similar to 301 of FIG. 3A, the representation is a “reverse portfolio data table” in that for each instrument, its position in each portfolio is represented in the reverse portfolio data. However, unlike 301, the data structure of 351 is sparse in that it does not contain any non-zero position entries. In the example, the data structure 351 contains five rows. Row 371 corresponds to portfolio P₁. Portfolios P₂-P₄₈ do not contain any shares/amounts of the instrument I₁, and thus are not included in 351. The next portfolio with a non-zero amount of instrument I₁ is portfolio P₄₉ as shown in row 372. Similarly, row 373 shows position data for portfolio 68, row 374 shows position data for portfolio 624, and row 375 shows position data for portfolio 777. In this way, even if there are many thousands of portfolios used for simulation, estimation, and/or risk measure analysis, the size of the reverse portfolio data is reduced to only those portfolios that contain a non-zero amount of the corresponding instrument (e.g., a non-zero number of shares, dollars, or other suitable unit).

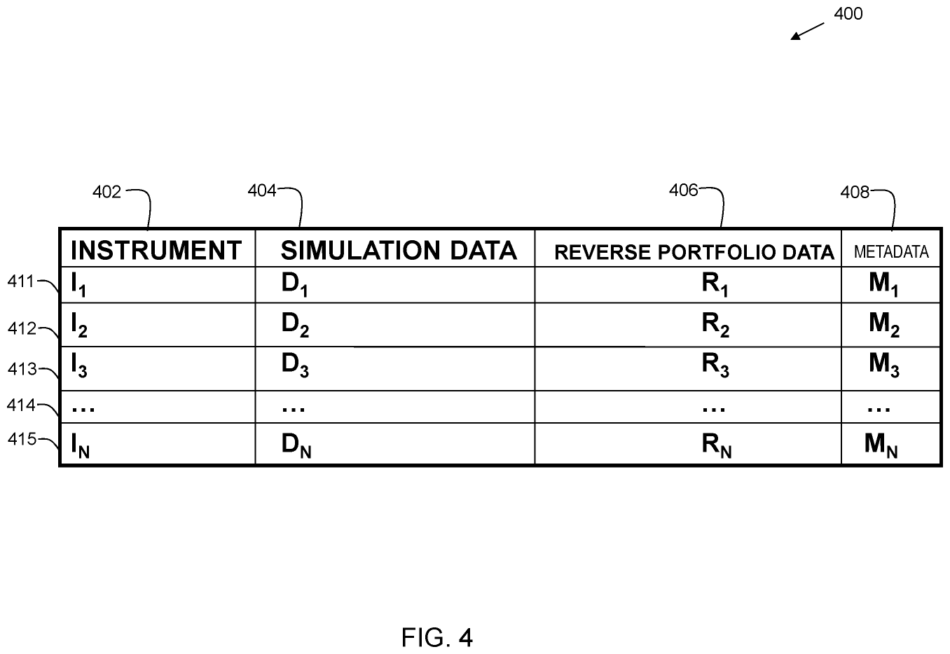

FIG. 4 shows an instrument information table 400 in accordance with embodiments of the present invention. Table 400 includes column 402 for each instrument that may be included in a portfolio. Each instrument may be designated by an identifier (indicated as I₁, I₂, I₃, etc.). The simulation data from table 200 (column 204) is in column 404, and the reverse portfolio data from table 300 (column 304) is in column 406. In embodiments, table 400 is formed by a join of table 200 of FIG. 2 and table 300 of FIG. 3 based on an instrument identifier in column 402.

At row 411, instrument I₁ references simulation data D₁, reverse portfolio data R₁, and metadata M₁. Similarly, at row 412, instrument I₂ references simulation data D₂, reverse portfolio data R₂, and metadata M₂. Similarly, at row 413, instrument I₃ references simulation data D₃, reverse portfolio data R₃, and metadata M₃. At row 414, the symbol “ . . . ” indicates multiple rows may be present between row 413 and the final row 415. Finally, at row 415, instrument I_{N} references simulation data D_{N}, reverse portfolio data R_{N}, and metadata M_{N}.

Optionally, the metadata from column 320 of FIG. 3 may also be present in column 408. With the structure shown in table 400, there is exactly one row (record) per instrument, and the data within that row contains multiple simulation scenarios and all the portfolios that contain that instrument, as well as the number of position units of that instrument within each portfolio. Thus, each record in table 400 comprises data fields of instrument, simulation values, and position units by portfolio. In this way, disclosed embodiments greatly reduce table sizes as compared with previous techniques. In disclosed embodiments, table 400 may include tens of millions of rows (records), while previous techniques require multiple tables utilizing trillions of records, which is orders of magnitude larger. There are many possible simulation scenarios, and with millions of possible combinations of instruments, the processing task can be very compute-intensive. Furthermore, the dynamic nature of today's business environment demands the capability to quickly recompute scenarios based on changing conditions. Thus, disclosed embodiments improve the technical field of financial risk management by more efficiently utilizing computer resources.

The embodiments utilizing table 400 provide improvements in the performance of databases for the technical field of financial analysis by greatly reducing the amount of computer memory required for computation. In practice, the table 400 may comprise tens of millions of records. In contrast, previous solutions require trillions of records in a situation where there are tens of millions of instruments, thousands of scenarios, hundreds of time steps, and hundreds of portfolios.

Furthermore, the simulation data in column 404 can be on the order of (thousands of scenarios) (hundreds of time steps) resulting in a size on the order of 100,000 values. Since languages such as Java and C often use 8 bytes to store a value, then 100,000 values will take 800,000 bytes. This is less than one megabyte per entry in column 404, thus providing efficient use of computing resources.

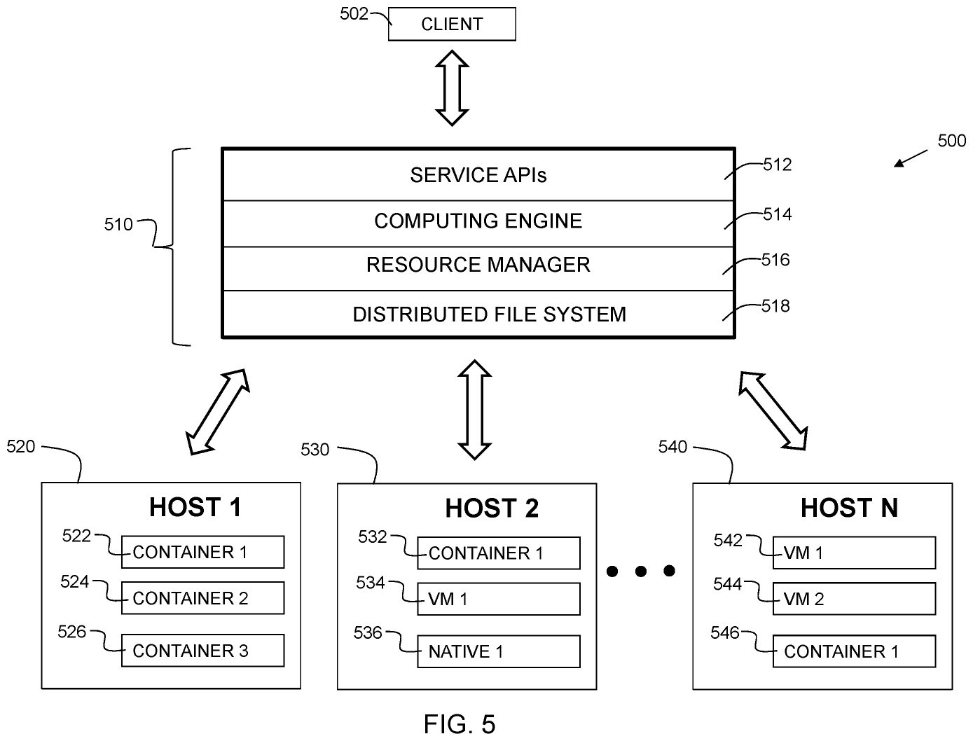

FIG. 5 shows an embodiment of the present invention utilizing a distributed computing architecture. System 500 is a distributed computing architecture. Client 502 is similar to client device 104 of FIG. 1. Instead of interacting with a single computer as in the system shown in FIG. 1, system 500 utilizes a distributed ecosystem 510. The distributed ecosystem 510 is a logical software stack that includes a distributed file system 518. In embodiments, the distributed file system can include, but is not limited to, Hbase, Hadoop Distributed File System (HDFS), or other suitable distributed file system. The distributed file system provides features such as location transparency and data redundancy. The distributed file system 518 allows data processing to be performed on a computing cluster using distributed data partitions stored locally on nodes in the most effective way, without significant data flow through the network. This results in the significant reduction of the processing time for large amounts of data (e.g., “Big Data” applications). In embodiments, each node can be started as a container or virtual machine. In some embodiments, a node may be started as a native process executing directly on host hardware.

The distributed file system 518 interacts with multiple processing nodes, implemented in multiple hosts. As shown in FIG. 5, there are computers that implement a cluster of nodes that interface with the distributed file system. These computers are Host 1 520, Host 2 530, and Host N 540. Host 1 520, Host 2 530, and Host N 540 are computer systems which may include thereon one or more containers, one or more virtual machines (VMs), or one or more native applications. These host machines are typically self-sufficient, including a processor (or multiple processors), memory, and instructions thereon. Host 1 520, Host 2 530, and Host N 540 are each computers that together implement a cluster. Note that while three hosts are shown in FIG. 5, in practice, embodiments may have many more than three hosts.

Host 1 520 includes instances of three containers: Container 1 522, Container 2 524, and Container 3 526. A container image is a lightweight, stand-alone, executable package of software that includes everything needed to perform a role that includes one or more tasks. The container can include code, runtime libraries, system tools, system libraries, and/or configuration settings. Containerized software operates with some independence regarding the host machine/environment. Thus, containers serve to isolate software from their surroundings. In some embodiments, the containers may be implemented as docker containers. Docker is a computer program that provides operating-system-level virtualization (i.e., containerization). Containers utilize the resource isolation features of the OS kernel (i.e., cgroups and kernel namespaces), and a union-capable file system (i.e., OverlayFS and others). This allows separate containers to run within a single operating system instance, circumventing the overhead of starting and maintaining virtual machines. Other container environments such as LXC may be used instead of, or in addition to, docker containers.

Host 2 530 includes instances of virtual machines, containers, and a native application. The container is Container 1 532. Native 1 536 is a native application, native instruction set, or other native program that is implemented specially for the particular model of the computer or microprocessor, rather than in an emulation mode.

The virtual machine is VM 1 534. A virtual machine (VM) is an operating system or application environment that is installed as software, which imitates dedicated hardware. The virtual machine imitates the dedicated hardware, providing the end user with the same experience on the virtual machine as they would have on dedicated hardware. Platforms such as Virtualbox or VMWare may be used to provide a virtual machine environment, which includes a host operating system and hypervisor. Host N 540 includes instances of two virtual machines: VM 1 542, and VM 2 544, along with Container 1 546.

Thus, in embodiments, the host can include a mix of containers, virtual machines, and/or native applications. In some embodiments, hosts can include only a single type of environment, such as containers, virtual machines, or native applications. Alternatively, a host may include a mix of such, like in the example of Host 2 530. In some cases, instances of the container, virtual machine, or native application may be replicated on more than one host. An example of this is shown here as an instance of Container 1 is executing on host 1 at 522, host 2 at 532, and host N at 546. An orchestration and/or management platform, such as Kubernetes and/or Ambari may be used for orchestration and management of containerized applications and clusters.

Referring again to the distributed ecosystem 510, a resource manager 516 is used to interface with the distributed file system 518. In embodiments, the resource manager may be Yarn, Mesos, or other suitable resource manager. A computing engine 514 is used to interface with the resource manager. In embodiments, the computing engine can include Hadoop MapReduce, Spark core, or other suitable computing engine. A service API layer 512 is used to interface between the client 502 and the computing engine 514. In embodiments, the service API layer 512, can include, but is not limited to, Pig, Hive, Spark SQL, and/or other suitable API libraries, functions, and/or modules. These APIs may provide SQL-like functionality, even if the underlying data storage is in a different format, such as flat files, CSV delimited data, NoSQL format, or other suitable format.

Note that the terms “HBASE, SPARK, PIG, HADOOP, HIVE, KUBERNETES, AMBARI, and DOCKER” may each be subject to trademark rights in various jurisdictions throughout the world. Each is used here only in reference to the products or services properly denominated by the mark to the extent that such trademark rights may exist.

The organization of data as shown in table 400 of FIG. 4 enables efficient computation of risk measures of portfolios in a distributed computing environment, since it allows for efficient storage of data. Additionally, localized processing of data reduces the amount of network bandwidth consumed during such computations.

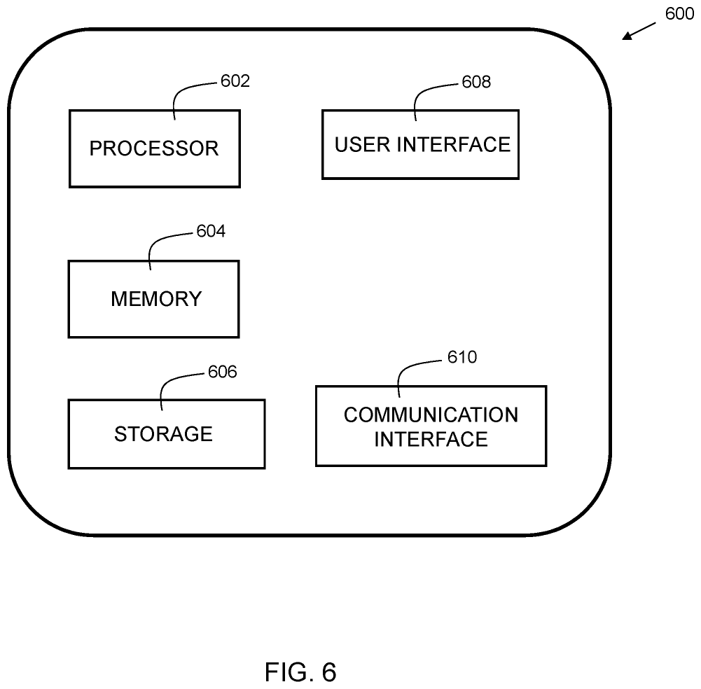

FIG. 6 is a block diagram of an electronic computing device 600 in accordance with embodiments of the present invention. This represents any of a host machine (520, 530, 540) or system 102 of FIG. 1. Device 600 includes a processor 602, which is coupled to a memory 604. Memory 604 may include dynamic random-access memory (DRAM), static random-access memory (SRAM), magnetic storage, and/or a read only memory such as flash, EEPROM, optical storage, or other suitable memory. In some embodiments, the memory 604 may not be a transitory signal per se.

Device 600 may further include storage 606. In embodiments, storage 606 may include one or more magnetic storage devices such as hard disk drives (HDDs). Storage 606 may additionally include one or more solid state drives (SSDs).

Device 600 may, in some embodiments, include a user interface 608. This may include a display, keyboard, mouse, or other suitable interface. In some embodiments, the display may be touch-sensitive.

The device 600 further includes a communication interface 610. The communication interface 610 may be a wired communication interface that includes Ethernet, Gigabit Ethernet, or the like. In embodiments, the network interface 610 may include a wireless communication interface that includes modulators, demodulators, and antennas for a variety of wireless protocols including, but not limited to, Bluetooth™, Wi-Fi, and/or cellular communication protocols for communication over a computer network. In embodiments, instructions are stored in memory 604. The instructions, when executed by the processor 602, cause the electronic computing device 600 to perform embodiments of the present invention.

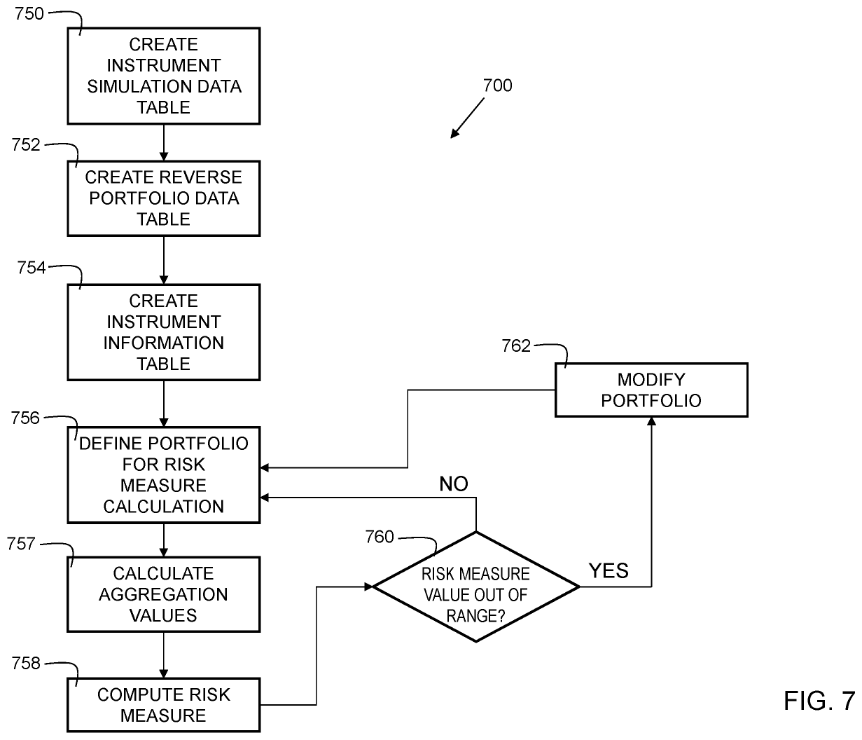

FIG. 7 is a flowchart 700 indicating process steps for embodiments of the present invention. In process step 750, an instrument simulation data table is created. This table, as illustrated in FIG. 2, contains instrument identifiers, and corresponding simulation data for each instrument. The simulation data contains estimated instrument values (e.g., share price) for multiple future times.

In process step 752, a reverse portfolio data table is created. This table, as illustrated in FIG. 3, contains instrument identifiers, and corresponding reverse portfolio data for each instrument. The reverse portfolio data identifies portfolios and position data for the instruments that are identified by the instrument identifiers.

In process step 754, an instrument information data table is created. This table, as illustrated in FIG. 4, contains instrument identifiers, simulation data from the instrument simulation data table, and corresponding reverse portfolio data from the reverse portfolio data table, for each instrument. The instrument information table is organized such that there is one row per instrument, and each row contains information regarding one or more simulations, reverse portfolio data, and optionally also includes metadata corresponding to each instrument.

Various situations can be simulated. Simulation scenarios can include, but are not limited to, interest rate changes, anticipated regulation changes, commodity price changes, weather (natural disaster) events, political events (e.g., election results, strikes, military conflicts), and/or other factors that can determine risk measure values.

In process step 756, a portfolio is defined for risk measure calculation. As an example, a portfolio may be defined to contain instruments and position amounts corresponding to an actual portfolio of a user. Additional portfolios can be created based on the actual portfolio, with one or more modifications applied. Modifications can include increasing or decreasing positions, and/or adding or removing instruments. Since the estimated performance of each instrument is computed a priori in the instrument simulation data table, it becomes straightforward and efficient to generate new portfolios and corresponding risk measure computations by creating reverse portfolio data entries for the new portfolio.

In process step 757, aggregation values are calculated for each portfolio. The aggregation values represent the estimated value of the portfolios at each time step for the various scenarios. In order to accomplish this, the simulation data for every record in the table is accumulated, adjusting for instrument positions in each portfolio. As an example, in Spark, the foreach action with accumulator can be used to accomplish this.

1. Accumulator accum

### 2. Portfolio p

3. For every Row do
4. pos=row.positionUnitsByPortfolio.get(p)
5. if (pos==null) return
6. accum.add(pos*row.simulationSheet)

The above instructions are exemplary, and other code sets, instruction sets, and/or programming languages may be utilized in some embodiments of the present invention.

In process step 758, the risk measure is computed. In embodiments, multiple risk measures may be computed for each portfolio. The risk measures can include, but are not limited to, value at risk (VaR), expected shortfall (ES), alpha, beta, Sharpe ratio, R-squared, and/or other suitable risk measures.

The VaR provides a measure of the risk of loss for investments. It estimates how much a portfolio might lose (with a given probability), under certain conditions, in a set time period such as a day, week, month, quarter, year, or other suitable time period. VaR is a useful metric for firms and regulators in the financial industry to gauge the amount of assets needed to cover possible losses. As an example, if a portfolio has a one-day 5% VaR of $100,000, that means that there is a probability of 0.05 that the portfolio will fall in value by more than $100,000 over a one-day period.

The estimated alpha measures risk relative to a selected benchmark index such as the Dow Jones Industrial average (DJI), S&P 500, or other suitable benchmark. For example, if the S&P 500 has been deemed the benchmark for a particular fund, the activity of the portfolio is compared to that estimated by the selected index. If the portfolio is estimated to outperform the benchmark, it has a positive estimated alpha. If the portfolio is estimated to fall below the performance of the benchmark, it is considered to have a negative estimated alpha.

The estimated beta measures the volatility or systemic risk of a portfolio in comparison to the market or the selected benchmark index. A beta value of one (1) indicates that the portfolio is expected to move in conjunction with the benchmark. Beta values below one are considered less volatile than the benchmark, while those over one are considered more volatile than the benchmark.

The R-squared value measures the percentage of an investment's movement that is attributable to movements in its benchmark index. An R-squared value represents the correlation between the examined portfolio and its corresponding benchmark. For example, an R-squared value of 95 would be considered to have a high correlation, while an R-squared value of 50 may be considered low.

The Sharpe ratio measures performance as adjusted by the associated risks. This is done by removing the rate of return on a risk-free investment, such as a U.S. Treasury Bond, from the estimated rate of return. This risk measure serves as an indicator of whether an investment's return is due to wise investing or due to the assumption of excess risk. Expected Shortfall is defined as the average of all losses which are greater or equal than VaR. That is, the average loss in the worst (1−p) percent of cases, where p is the confidence level.

The expected excess return refers to investment returns from a portfolio that exceed the riskless rate on a security that is generally perceived to be risk free, such as a certificate of deposit or a government-issued bond. Furthermore, the concept of excess returns may also be applied to returns that exceed a particular benchmark, or index with a similar level of risk. Determining the excess returns involves subtracting of the riskless rate, or benchmark rate, from the actual rate achieved. A negative expected excess indicates a level of risk for a portfolio to underperform in comparison to the riskless rate or benchmark.

Embodiments include computing a value at risk (VaR) for a portfolio from the plurality of portfolios. Embodiments include computing an expected shortfall for a portfolio from the plurality of portfolios. Embodiments include computing an expected excess return for at least one portfolio from the plurality of portfolios. The aforementioned risk measures are merely examples. Other risk measures are possible in embodiments of the present invention.

In embodiments, the process proceeds to process step 760, where a risk measure value is compared to a predetermined threshold or range. If the risk measure value exceeds the predetermined threshold, or is outside of a predetermined range, then the process continues to process step 762. At 762, the portfolio is modified in response to computing a risk measure value out of range. Thus, embodiments can include, in response to computing a VaR exceeding a predetermined threshold, performing an automated portfolio adjustment. As an example, a VaR of $100,000 may be established. In the event that a computed VaR for a portfolio exceeds $100,000, then the portfolio is modified by buying or selling of instruments. Thus, in embodiments, performing the automated portfolio adjustment includes reducing a position of an instrument in the portfolio. In some embodiments, the position of an instrument in the portfolio may be reduced to zero, effectively removing that instrument from the portfolio. In embodiments, performing the automated portfolio adjustment includes increasing a position of an instrument in the portfolio. The portfolio modification can occur via an automated trading system, or other suitable trading platforms.

As an example, with disclosed embodiments of the present invention, an investor (user) has a portfolio that contains a mix of stocks from various industry sectors. A what-if scenario can be generated to estimate risk measures if new energy regulations are passed. From the instrument simulation data table, estimated performance of each instrument based on that scenario is applied to the portfolio, and the risk measure is computed. Additional what-if scenarios can be easily generated. For example, a new portfolio with reduced positions in energy sector stocks can be quickly generated by making new entries in the reverse portfolio data table with the updated position levels for the energy sector instruments, and the risk measure can then be recomputed.

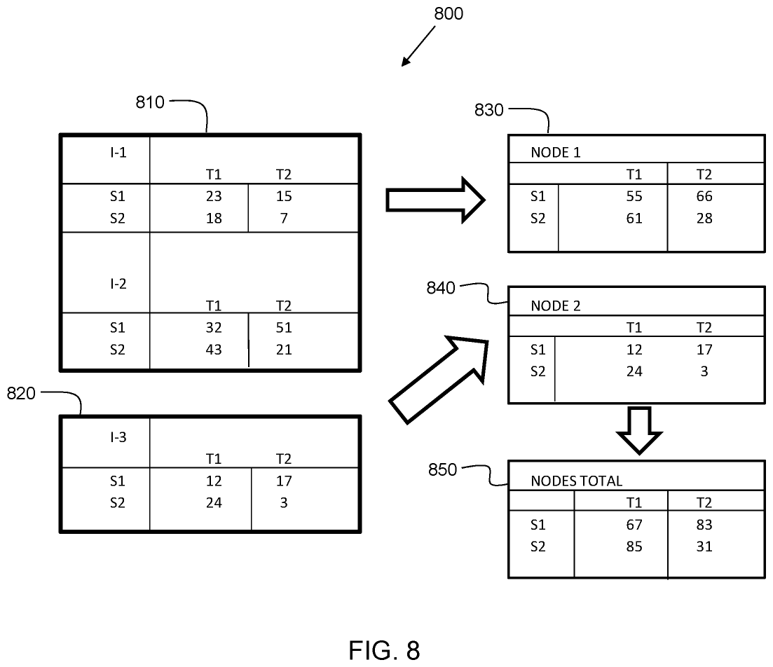

FIG. 8 shows an example 800 of calculating aggregation values in a distributed computing architecture. Data table 810 represents instrument data for two instruments (I-1 and I-2) that are part of a portfolio, and residing on a computing node (e.g., 522 of FIG. 5). Data table 820 represents data for a third instrument (I-3) that is also part of the portfolio, but residing on a second computing node (e.g., 532 of FIG. 5). Parallel operations can reduce the time required to compute the aggregation values. In embodiments, the instrument values for each instrument within a node are aggregated. As an example, data table 830 represents the value of the sum of the instruments in the node adjusted for instrument positions in the portfolio using the reverse portfolio data. In this case, each data value in data table 830 is the sum of the value of instrument I-1 and I-2 at each timestep (T1, T2) for the simulations (S1, S2), where values of instrument I-1 and I-2 are adjusted for their corresponding positions in the portfolio. Furthermore, data table 840 represents the sum of the instruments contained within data table 820, which corresponds to the second computing node. In this case, since data table 820 only contained a single instrument (I-3), the values in table 840 are adjusted for instrument I-3 positions in the portfolio in table 820. In data table 850, the subtotals from each node are aggregated. While the example of FIG. 8 utilized three instruments distributed over two nodes, in practice, there can be many more instruments and many more nodes. Furthermore, the example of FIG. 8 illustrates a single portfolio, and in practice there can be many portfolios. With a scalable distributed architecture such as shown in FIG. 5, it is possible to compute aggregation values for multiple scenarios and portfolios in a time-efficient manner. Once the aggregation values are computed, a multitude of risk measures, such as value at risk (VaR), expected shortfall (ES), and many others, can be efficiently computed using embodiments of the present invention.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

As can now be appreciated, disclosed embodiments provide for improved performance of databases, and distributed computing systems that enable improvements in financial risk computations. This enables improvements in the technical field of financial risk management by organization of data, utilizing a reverse portfolio data table and an instrument information table. Thus, disclosed embodiments provide a logical model that includes all data entities in a single instrument information table. This table enables efficient aggregation techniques based on Big Data technology, which allows optimization of data volume and reduction of processing time during aggregation in a distributed computing environment. Disclosed embodiments leverage distributed computing environments to compute financial risk measures more accurately and with less memory usage, processing time, and power consumption, as compared with previous risk measure computation techniques.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

1. A computer-implemented method for risk measure calculation for a plurality of financial instruments, comprising:
creating an instrument simulation data table, comprising, for each instrument, a two-dimensional array defining scenarios and timestep simulation information, wherein each record contains timesteps, and simulation information for a plurality of scenarios, for an instrument from the plurality of financial instruments;
creating a reverse portfolio data table, comprising, for each instrument, a tuple comprising position units for a portfolio from a plurality of portfolios, wherein each portfolio includes one or more instruments from the plurality of financial instruments; and
joining the instrument simulation data table and the reverse portfolio data table based on an instrument identifier to create an instrument information table comprising one record per instrument, wherein each record comprises data fields of instrument, simulation values, and position units by portfolio.

2. The computer-implemented method of claim 1, further comprising computing a value at risk (VaR) for a portfolio from the plurality of portfolios.

3. The computer-implemented method of claim 1, further comprising computing an expected shortfall for a portfolio from the plurality of portfolios.

4. The computer-implemented method of claim 1, further comprising computing an expected excess return for at least one portfolio from the plurality of portfolios.

5. The computer-implemented method of claim 2, further comprising, in response to computing a VaR exceeding a predetermined threshold, performing an automated portfolio adjustment.

6. The computer-implemented method of claim 5, wherein performing the automated portfolio adjustment includes reducing a position of an instrument in the portfolio.

7. The computer-implemented method of claim 5, wherein performing the automated portfolio adjustment includes increasing a position of an instrument in the portfolio.

8. An electronic computation device comprising:
a processor;
a memory coupled to the processor, the memory containing instructions, that when executed by the processor, perform the process of:
creating an instrument simulation data table, comprising, for each instrument, a two-dimensional array defining scenarios and timestep simulation information, wherein each record contains timesteps, and simulation information for a plurality of scenarios, for an instrument from the plurality of financial instruments;
creating a reverse portfolio data table, comprising, for each instrument, a tuple comprising position units for a portfolio from a plurality of portfolios, wherein each portfolio includes one or more instruments from the plurality of financial instruments; and
joining the instrument simulation data table and the reverse portfolio data table based on an instrument identifier to create an instrument information table comprising one record per instrument, wherein each record comprises data fields of instrument, simulation values, and position units by portfolio.

9. The electronic computation device of claim 8, wherein the memory further comprises instructions, that when executed by the processor, perform a process of computing a value at risk (VaR) for a portfolio from the plurality of portfolios.

10. The electronic computation device of claim 8, wherein the memory further comprises instructions, that when executed by the processor, perform a process of computing an expected shortfall for a portfolio from the plurality of portfolios.

11. The electronic computation device of claim 8, wherein the memory further comprises instructions, that when executed by the processor, perform a process of computing an expected excess return for at least one portfolio from the plurality of portfolios.

12. The electronic computation device of claim 9, wherein the memory further comprises instructions, that when executed by the processor, perform an automated portfolio adjustment in response to computing a VaR exceeding a predetermined threshold.

13. The electronic computation device of claim 12, wherein the memory further comprises instructions, that when executed by the processor, perform a process of reducing a position of an instrument in the portfolio.

14. The electronic computation device of claim 12, wherein the memory further comprises instructions, that when executed by the processor, perform a process of increasing a position of an instrument in the portfolio.

15. A computer program product for an electronic computation device comprising a computer readable storage medium having program instructions embodied therewith, the program instructions executable by a processor to cause the electronic computation device to perform the process of:
creating an instrument simulation data table, comprising, for each instrument, a two-dimensional array defining scenarios and timestep simulation information, wherein each record contains timesteps, and simulation information for a plurality of scenarios, for an instrument from the plurality of financial instruments;
creating a reverse portfolio data table, comprising, for each instrument, a tuple comprising position units for a portfolio from a plurality of portfolios, wherein each portfolio includes one or more instruments from the plurality of financial instruments; and
joining the instrument simulation data table and the reverse portfolio data table based on an instrument identifier to create an instrument information table comprising one record per instrument, wherein each record comprises data fields of instrument, simulation values, and position units by portfolio.

16. The computer program product of claim 15, wherein the computer readable storage medium includes program instructions executable by the processor to cause the electronic computation device to perform the process of computing a value at risk (VaR) for a portfolio from the plurality of portfolios.

17. The computer program product of claim 15, wherein the computer readable storage medium includes program instructions executable by the processor to cause the electronic computation device to perform a process of computing an expected shortfall for a portfolio from the plurality of portfolios.

18. The computer program product of claim 15, wherein the computer readable storage medium includes program instructions executable by the processor to cause the electronic computation device to perform a process of computing an expected excess return for a portfolio from the plurality of portfolios.

19. The computer program product of claim 16, wherein the computer readable storage medium includes program instructions executable by the processor to cause the electronic computation device to perform a process of an automated portfolio adjustment in response to computing a VaR exceeding a predetermined threshold.

20. The computer program product of claim 19, wherein the computer readable storage medium includes program instructions executable by the processor to cause the electronic computation device to perform a process of reducing a position of an instrument in the portfolio, or to perform a process of increasing a position of an instrument in the portfolio.

21. The computer-implemented method of claim 5, further comprising: causing the automated portfolio adjustment to be executed by an automated trading system.

22. The electronic computation device of claim 12, wherein the memory further comprises instructions, that when executed by the processor, cause the automated portfolio adjustment to be executed by an automated trading system.

23. The computer program product of claim 19, wherein the computer readable storage medium includes program instructions executable by the processor to cause the electronic computation device to cause the automated portfolio adjustment to be executed by an automated trading system.
